(19) United States
(12) Patent Application Publication
(10) Pub. No.: US 2004/0136489 A1
(43) Pub. Date: Jul. 15, 2004

(54) Nuclear reactor containment vessel

(75) Inventor: Munetaka Takahashi, Kanagawa-ken (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/625,844

(22) Filed: Jul. 24, 2003

(30) Foreign Application Priority Data
Jul. 29, 2002 (JP) 2002-219562

(51) Int. Cl. G21C 9/00

(52) U.S. Cl. 376/293

(57) ABSTRACT

A reactor containment vessel of a boiling water reactor configured to contain a reactor pressure vessel. The reactor pressure vessel is connected to at least one main steam pipe which penetrates the reactor containment vessel at a main-steam-line penetration point. The main-steam-line penetration point is disposed on a first side of the reactor containment vessel. Distance between outer surface of the reactor pressure vessel and inner surface of the reactor containment vessel on the first side is longer than the distance on a second side which is opposite to the first side.

### BACKGROUND OF THE INVENTION

This invention is related generally to a containment vessel for a boiling water nuclear reactor, and more particularly to a containment vessel that can be designed compact considering the piping.

A prior art containment vessel of a boiling water reactor is shown in FIGS. 5 and 6. A reactor pressure vessel 1 is contained in a reactor containment vessel 2. The horizontal cross-sections of the reactor pressure vessel 1 and the reactor containment vessel 2 are shaped in co-central circles. Four main steam pipes 4 and two feed water pipes 5 are connected to the reactor pressure vessel 1 in this example. Those pipes 4 and 5 are disposed in an upper drywell in the reactor containment vessel 2 and penetrate the wall of the reactor containment vessel 2 at main-steam-line penetration points 8 and feed-water-line penetration points 20, respectively.

The connecting points of the main steam pipes 4 to the reactor pressure vessel 1 are disposed at a higher level than the connecting points of the feed water pipes 5 to the reactor pressure vessel 1. The main-steam-line penetration points 8 are disposed higher than the feed-water-line penetration points 20, forming two levels of penetration points. The main-steam-line penetration points 8 and the feed-water-line penetration points 20 are both arranged on the side of the turbine building (not shown) (on “0-degree” side). The turbine building is arranged adjacent to the reactor containment vessel 2.

The upper drywell contains the reactor pressure vessel 1 and the portions of the main steam pipes 4 and the feed water pipes 5 which are disposed in the reactor containment vessel 1. A lower drywell 11 is formed below the reactor pressure vessel 1, in the reactor containment vessel 2. A wetwell 22, which includes an annulus suppression pool 12, surrounds the lower drywell 11, under the upper drywell 3.

The reactor containment vessel 2 is designed considering the layout of the main steam pipes 4 and the safety-relief valves 9 and the main-steam-line isolation valves 10. The safety-relief valves 9 and the main-steam-line isolation valves 10 are disposed on the main steam pipes 4 between the main-steam pipe outlet nozzles 7 and the main-steam-line penetration points 8. The layout of the main steam pipes 4 is restricted by the minimum curvature radius. The height of the upper drywell 3 is decided considering the height required for maintenance of the main-steam-line isolation valves 10, and the size of the feed-water-line penetration points 20. The main-steam-line isolation valves 10 are disposed at the main-steam-line penetration points 8. The feed-water-line penetration points 20 are disposed below the main steam pipes 4.

Access tunnels 13 are disposed penetrating the suppression pool 12. The access tunnels 13 communicate inside of the lower drywell and outside of the reactor containment vessel 2, so that operators may enter the lower drywell 11 through the access tunnels 13. The access tunnels 13 extend substantially horizontally and straight, and have airtight radiation shielding doors. The access tunnels 13 are disposed in the directions of 0 degrees and 180 degrees in the example shown in FIG. 5.

Gas in the upper drywell 3 is conditioned by reactor-containment-vessel air conditioners 6. The reactor-containment-vessel air conditioners 6 are disposed on the 180-degree side in the upper drywell 3. The reactor-containment-vessel air conditioners 6 are disposed further from the main-steam-line penetration points 8 and the feed-water-line penetration points 20, This position of the reactor-containment-vessel air conditioners 6 is selected because this area is less crowded with the piping and has a space to spare. The upper drywell 3 is filled with nitrogen gas during the nuclear reactor's operation. The reactor-containment-vessel air conditioners 6 are used for cooling the nitrogen gas.

If the main steam pipe 4 had a rupture in the upper drywell 3, the main-steam-line isolation valves 10 would be closed. Then, the safety-relief valves 9 on the main steam pipe 4 would be opened, and the steam would blow out through the quenchers 14 in the suppression pool 12 so that the steam might be condensed. The quenchers 14 in the suppression pool 12 are distributed uniformly or proportionally to the volume of the suppression pool 12. The steam, which were blown out from the main steam pipes 4 to the upper drywell 3, would be guided through the vent pipes 15 to the suppression pool 12. The steam is condensed in the suppression pool 12.

The suppression pool 12 has the volume, so that the steam blown out to the upper drywell 3 and the lower drywell 11 may be condensed. Therefore, the volume of the suppression pool 12 is decided based on the sum of the volumes of the upper drywell 3, the lower drywell 11 and the access tunnel 13.

The fuels are stored in a fuel storage pool 16 disposed outside of the reactor containment vessel 2 after the fuels are taken out of the reactor pressure vessel 1 during periodic inspection time, for example. The fuels must be kept vertical, and the whole length of the fuels must be submerged in the fuel storage pool 16. The fuel storage pool 16 has a fuel storage area 17, which has enough depth outside of a shallow area above the upper drywell 3. The fuel storage area 17 has a side wall common with part of the side wall of the reactor containment vessel 2.

Control rod drive mechanism 25 of the example shown in FIG. 6 is disposed below the reactor pressure vessel 1 in the lower drywell 11, and the control rods are inserted upward.

In the prior art described above, the reactor pressure vessel 1 and the reactor containment vessel 2 are arranged con-centered. The required minimum inner diameter of the reactor containment vessel 2 is decided mainly based on the layout of the devices including the main steam pipes 4 on the 0-degree side. The 0-degree side of the reactor containment vessel 2 is crowded with devices including piping, while the 180-degree side of the reactor containment vessel 2 is less crowded. That is a problem to be solved in order to reduce the size of the reactor containment vessel 2. In addition, since the access tunnels 13 are long and the volumes of the access tunnels 13 are large, the volume of suppression pool 12 is large. The large volume of suppression pool 12 makes the total volume of the reactor containment vessel 2 large, and then the reactor building containing the reactor containment vessel 2 is large. That is another problem to be solved.

Furthermore, since the main-steam-line penetration points 8 and feed-water-line penetration points 20 are arranged in two levels, two support floors are arranged above the drywell floor 30. They are a support floor 31 over the main steam pipes 4 and a support floor 83 over the feed water pipes 5. Therefore, the required height of the upper drywell 3 cannot be reduced and the volume of the reactor containment vessel 2 cannot be reduced.

### BRIEF SUMMARY OF THE INVENTION

Accordingly, it is an object of the present invention to provide an improved reactor containment vessel that can have a reduced total volume.

There has been provided, in accordance with an aspect of the present invention, a reactor containment vessel of a boiling water reactor configured to contain a reactor pressure vessel, the reactor pressure vessel being connected to at least one main steam pipe which penetrates the reactor containment vessel at a main-steam-line penetration point, wherein: the main-steam-line penetration point is disposed on a first side of the reactor containment vessel; and distance between outer surface of the reactor pressure vessel and inner surface of the reactor containment vessel on the first side is longer than the distance on a second side which is opposite to the first side.

There has also been provided, in accordance with another aspect of the present invention, a reactor containment vessel of a boiling water reactor configured to contain a reactor pressure vessel, the reactor pressure vessel being connected to at least one main steam pipe and at least one feed water pipe, which penetrate the reactor containment vessel at a main-steam-line penetration point and at a feed-water-line penetration point, respectively, wherein the main-steam-line penetration point and the feed-water-line penetration point are arranged at substantially same level.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a schematic plane cross-sectional view of a first embodiment of a reactor containment vessel according to the present invention;

FIG. 2 is a schematic elevational cross-sectional view of the reactor containment vessel shown in FIG. 1;

FIG. 3 is a schematic plane cross-sectional view of a second embodiment of a reactor containment vessel according to the present invention;

FIG. 4 is a schematic elevational cross-sectional view of the reactor containment vessel shown in FIG. 3;

FIG. 5 is a schematic plane cross-sectional view of a prior-art reactor containment vessel; and

FIG. 6 is a schematic elevational cross-sectional view of the reactor containment vessel shown in FIG. 5.

### DETAILED DESCRIPTION OF THE INVENTION

In the following description and also in the above description of background of the invention, like reference numerals represent like elements, and redundant description may be omitted.

### [First Embodiment]

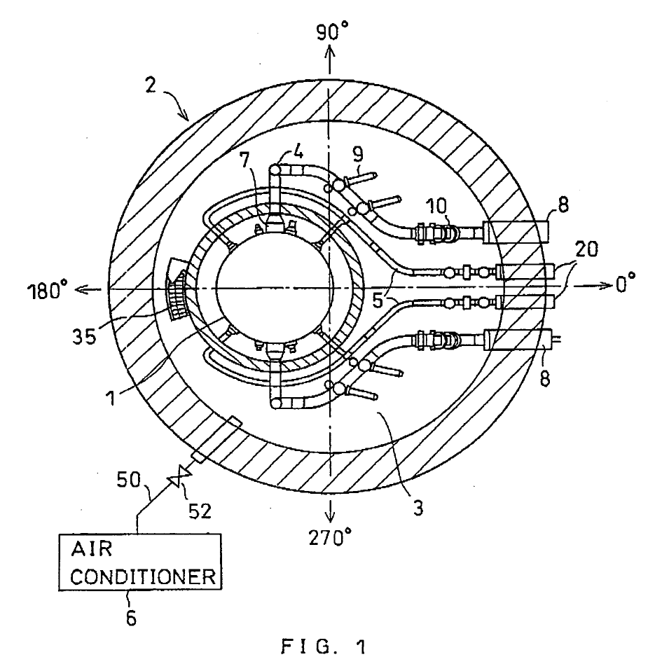

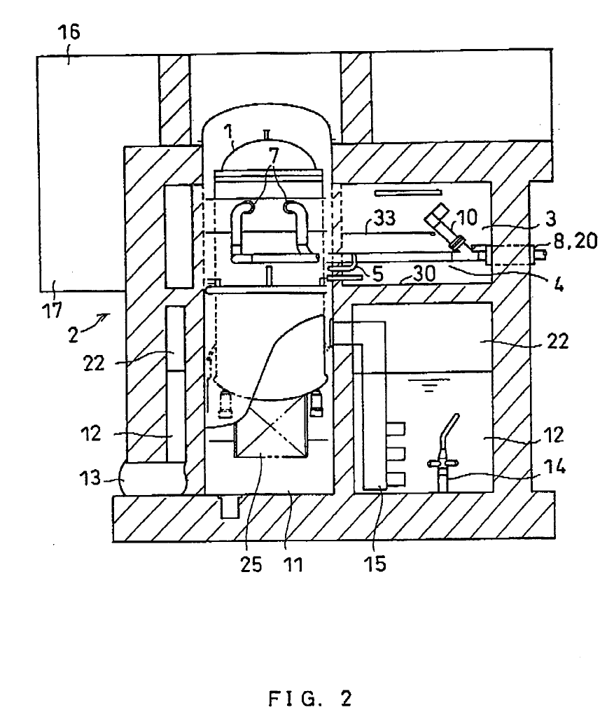

A first embodiment of a reactor containment vessel according to the present invention is now described with reference to FIGS. 1 and 2. The reactor containment vessel 2 contains the reactor pressure vessel 1. The shapes of the reactor pressure vessel 1 and the reactor containment vessel 2 in a horizontal cross-section are substantially circles. The main-steam-line penetration points 8 and the feed-water-line penetration points 20 are both arranged by “0-degree” side. In the present embodiment, the center of the reactor pressure vessel 1 is disposed offset from the center of the reactor containment vessel 2 in the 180-degree direction. That is, the space between the inner surface of the reactor containment vessel 2 and the outer surface of the reactor pressure vessel 1 is wider in the 0-degree side than in the 180-degree side.

In FIG. 1, a dot dash line in 0-180-degree direction is a center line (a first axis) of the reactor containment vessel 2 and another dot dash line in 90-270-degree direction is a center line (a second axis) of the reactor pressure vessel 1. The center of the reactor pressure vessel 1 is offset in 180-degree direction from the second axis of the reactor containment vessel 2.

The centers of the reactor pressure vessel 1 and the reactor containment vessel 2 are not offset in 90-degree or in 270-degree directions in the present embodiment shown in FIG. 1. However, the centers may be offset in 90-degree or in 270-degree directions if the offset amount is smaller than the offset amount in the 180-degree direction.

The main steam pipes 4 and the feed water pipes 5 are laid out on the 0-degree side in the upper drywell 3. A stair 35 around the reactor pressure vessel 1 is disposed in this embodiment as shown in FIG. 1. The stair 35 may be disposed in other place.

The reactor-containment-vessel air conditioner 6 is disposed outside of the reactor containment vessel 2. The reactor-containment-vessel air conditioner 6 conditions the air or nitrogen gas in the reactor containment vessel 2 through an air-conditioner duct 50 and an air-conditioner-duct isolation valve 52.

The diameter of the reactor containment vessel 2 is decided focussing attention on the layouts of the access space and the main steam pipes 4 on the 0-degree side. The layout of the main steam pipes 4 is decided considering mainly the minimum curvature radius of the main steam pipes 4 and the layout of the safety-relief valves 9 and the main steam isolation valves 10. The safety-relief valves 9 and the main steam isolation valves 10 are disposed between the main-steam-pipe outlet nozzles 7 and the main-steam-line penetration points 8.

The main steam pipes 4 and the feed water pipes 5 are arranged horizontally at a same level in the upper drywell 3. The pipes 4 and 5 penetrate the wall of the reactor containment vessel 2 at the main-steam-line penetration points 8 and at the feed-water-line penetration points 20, respectively. Only one support floor 33 is enough for both the feed water pipes 5 and the main steam pipes 4 above the drywell floor 30. Then, the height of the upper drywell 3 can be reduced compared to the prior art, which has two levels of the support floors.

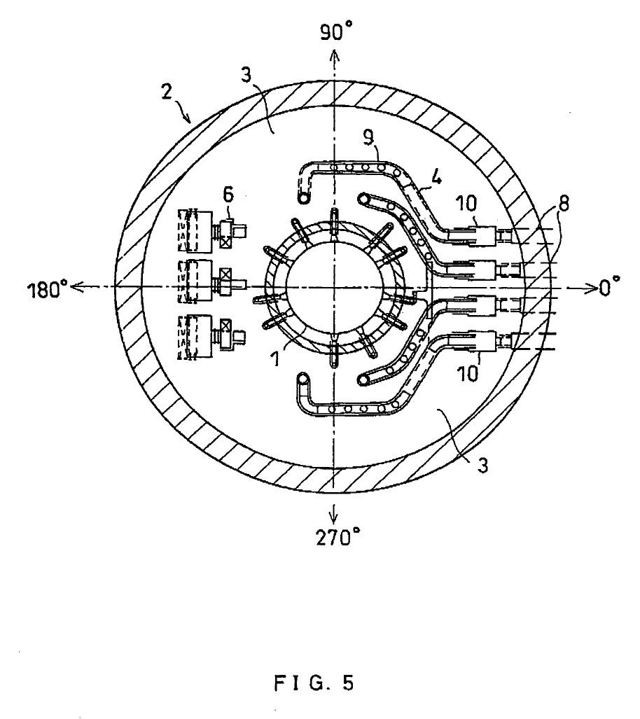

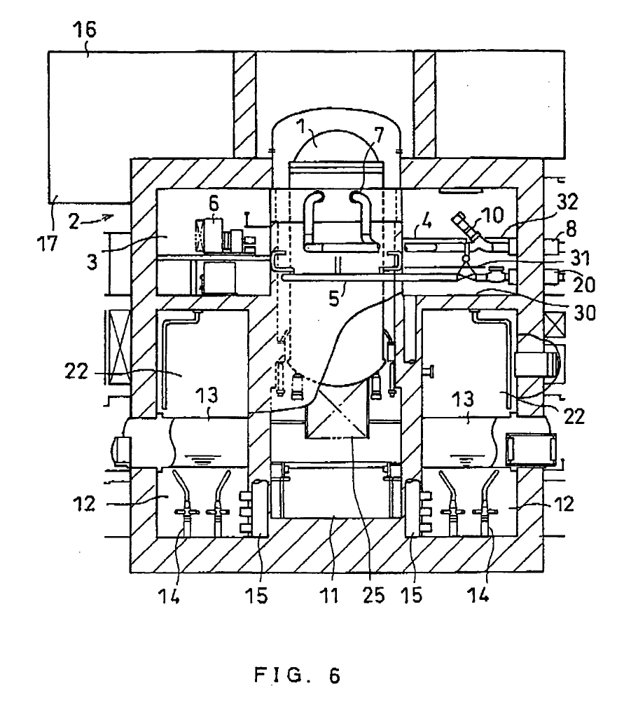

Two main steam pipes 4 and two feed water pipes 5 are connected to the reactor pressure vessel 1 in the embodiment shown in FIGS. 1 and 2. However the numbers of the pipes 4 and 5 are arbitrarily selected. For example, if four main steam pipes 4 and two feed water pipes 5 are connected to the reactor pressure vessel 1 as in the prior art shown in FIGS. 5 and 6, the four main-steam-line penetration points 8 and two feed-water-line penetration points 20 may be all arranged in a horizontal plane on the 0-degree side.

A lower drywell 11 is formed below the reactor pressure vessel 1, in the reactor containment vessel 2. A wetwell 22 surrounds the lower drywell 11, under the upper drywell 3. The wetwell 22 includes an annulus suppression pool 12.

The lower drywell 11 is accessible from outside of the reactor containment vessel 2 through the access tunnel 13. The access tunnel 13 penetrates the suppression pool 12, which is disposed under the upper drywell 3. The access tunnel 13 is disposed on the 180-degree side. The gap between the walls of the lower drywell 11 and the reactor containment vessel 2 is smallest on the 180-degree side. According to this embodiment, since the distance between the walls of the lower drywell 11 and the reactor containment vessel 2 is small, the access channel 13 can be shortened.

There may be a plurality of access tunnels in the reactor containment vessel 2. All of the access tunnels 13 are preferably disposed near the 180-degree position, since the access tunnels 13 can be shortened there.

The suppression pool 12 is eccentric annulus like the upper drywell 3, because the wall of the upper drywell 3 is continuous to the wall of the suppression pool 12. The quenchers 14 in the suppression pool 12 are distributed proportionally to the volume distribution of the suppression pool 12. Therefore, the quenchers 14 are distributed biased to the 0-degree side. That is preferable because the safety-relief valves 9 on the main steam pipes 4 in the upper drywell 3 are situated on the 0-degree side and the pipes between the safety-relief valves 9 and the quenchers 14 can be reduced. The vent pipes 15 are also advantageously distributed biased to the 0-degree side close to the main steam pipes 4 which are assumed to have a rupture.

The volume of the suppression pool 12 is calculated based on a sum of the volumes of the upper drywell 3, the lower drywell 11 and the access tunnel 13 so as to condense the steam blown out.

The fuel storage pool 16 has shallow area above the upper drywell 3. The shallow area in the fuel storage pool 16 is narrow on the 180-degree side. The fuel storage area 17 is situated on the 180-degree side. In this embodiment, the horizontal distance between the reactor pressure vessel 1 and the fuel storage area 17 is advantageously reduced, because the distance between the outer surface of the reactor containment vessel 2 and the wall of the reactor pressure vessel 1 is short.

In the first embodiment as shown in FIG. 2, the control rod drive mechanism 25 is disposed below the reactor pressure vessel 1 in the lower drywell 11 as the prior art shown in FIG. 6. Alternatively, the control rod drive mechanism 25 can be disposed above the reactor pressure vessel 1.

According to the first embodiment described above, the diameter of the reactor containment vessel 2 can be reduced by the eccentric arrangement of the reactor pressure vessel 1 and the reactor containment vessel 2. The height of the reactor containment vessel 2 can be reduced by the horizontal arrangement of the main steam pipes 4 and the feed water pipes 5. The volume of the access tunnels 13 can be reduced by shortening the access tunnels 13. The volume of the suppression pool 12 can also be reduced owing to the reduction of the above-mentioned volumes, and then, the total volume of the reactor containment vessel 2 can be reduced.

The shallow area in the fuel storage pool 16 is reduced by the eccentric arrangement of the reactor pressure vessel 1 and the reactor containment vessel 2. Thus, the area of the fuel storage pool 16 can be reduced. Because the top slab of the reactor containment vessel 2 is shortened on the side of the fuel storing area 17, the fuel transfer length on the top slab to the fuel storing area 17 outside of the reactor containment vessel wall is shortened. The shortened transfer length can result in shortened fuel transfer time, which can shorten the periodic inspection time.

The load and capacity of the reactor-containment-vessel air conditioner 6 of the present embodiment can be reduced, because it is disposed outside of the reactor containment vessel 2. In the prior art, the reactor-containment-vessel air conditioner 6 is disposed in the reactor containment vessel 2 and has to air-condition the air conditioner 6 itself. However the volume of he reactor containment vessel 2 can be reduced, even if the reactor-containment-vessel air conditioner 6 is disposed inside of the reactor containment vessel 2. Then, the reactor-containment-vessel air conditioner 6 may be optionally disposed inside of the reactor containment vessel 2.

The distances between the quenchers 14 and the safety-relief valves 9 can be reduced, according to disposing the suppression pool 12 offsetting toward the 0-degree direction. Furthermore, the vent pipes 15 can be distributed biased to the 0-degree side, approaching the main steam pipes 4 that might have an assumed rupture.

### [Second Embodiment]

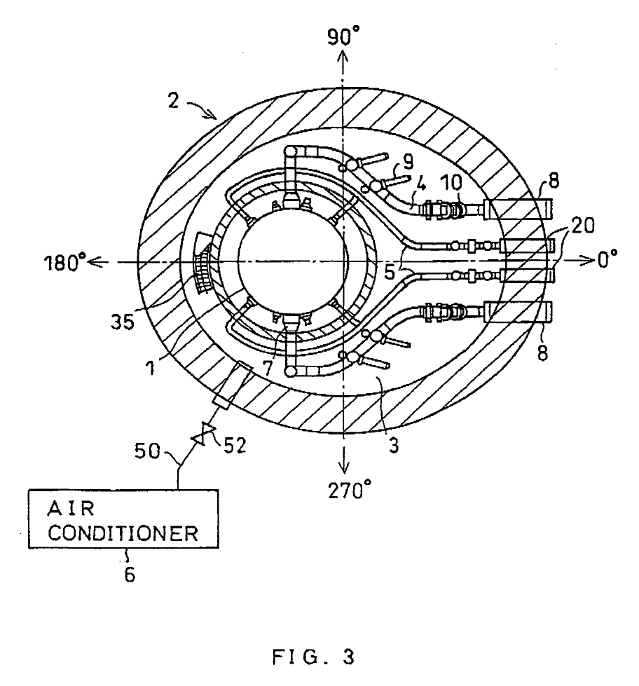

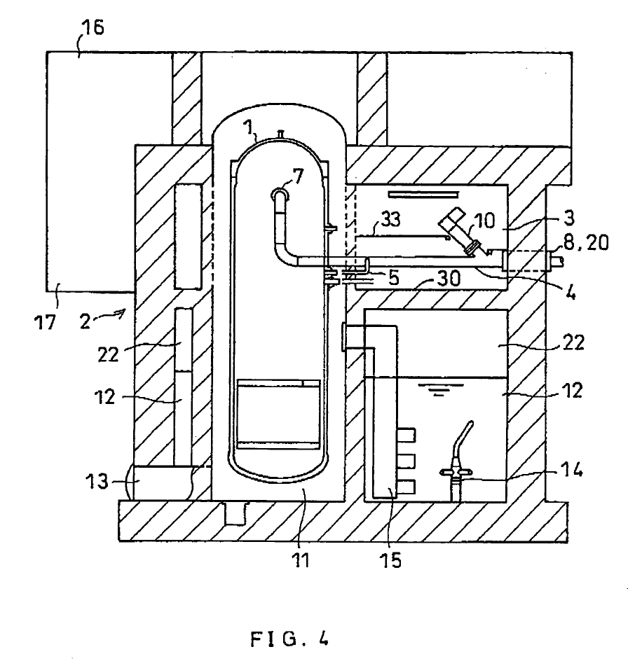

A second embodiment of a reactor containment vessel according to the present invention is now described with reference to FIGS. 3 and 4. The reactor containment vessel 2 of this embodiment has an oval horizontal cross-sectional shape. The horizontal cross-sectional shape is longer in the direction of 0 degrees and 180 degrees compared to its perpendicular direction.

In FIG. 2, a dot dash line in 0-180-degree direction is a major axis (a first axis) of the reactor containment vessel 2 and another dot dash line in 90-270-degree direction is a minor axis (a second axis) of the reactor containment vessel 2. The center of the reactor pressure vessel 1 is offset in 180-degree direction from the second axis of the reactor containment vessel 2. The span of the inner surface of the reactor containment vessel 2 on the first axis may not be the longest span of the inner surface of the reactor containment vessel 2, if the horizontal cross-sectional shape of the reactor containment vessel 2 is not an ellipse.

The main-steam-line penetration points 8 and the feed-water-line penetration points 20 are positioned in around 0-degree direction in the reactor containment vessel 2. The horizontal cross-sectional shape may not be oval if it is non-circular and longer in the direction of 0 degrees and 180 degrees. The reactor pressure vessel 1 is positioned offsetting toward the 180-degree direction in the reactor containment vessel 2, The distance between the outer surface of the reactor pressure vessel 1 and the inner surface of the reactor containment vessel 2 is similar to each other in the directions of 90, 180 and 270 degrees, while it is longer in about 0-degree direction.

The distance between the outer surface of the reactor pressure vessel 1 and the inner surface of the reactor containment vessel 2 may be alternatively different in the directions of 90, 180 and 270 degrees, if those distances are shorter than the distance in the 0-degree direction.

The reactor-containment-vessel air conditioner 6 is disposed outside of the reactor containment vessel 2 as in the first embodiment.

The inner size of the reactor containment vessel 2 is decided based on the access space and the layout of the piping etc. including the layout of the main steam pipes 4 on the 0-degree side. The layout of the main steam pipes 4 is decided considering mainly the minimum curvature radius of the main steam pipes 4 and the layout of the safety-relief valves 9 and the main steam isolation valves 10. The safety-relief valves 9 and the main steam isolation valves 10 are disposed between the main-steam-pipe outlet nozzles 7 and the main-steam line penetration points 8.

The main steam pipes 4 and the feed water pipes 5 are laid out in a same horizontal level in the upper drywell 3, and penetrate the wall of the reactor containment vessel 2 at the main-steam-line penetration points 8 and at the feed-water-line penetration points 20, respectively. The main-steam-line penetration points 8 and at the feed-water-line penetration points 20 are aligned in the same level on the 0 degree side.

The lower drywell 11 is accessible from outside of the reactor containment vessel 2 through the access tunnel 13. The access tunnel 13 penetrates the suppression pool 12. The suppression pool 12 is disposed under the upper drywell 3. The access tunnel 13 is disposed on the 180-degree side where the gap between the walls of the lower drywell 11 and the reactor containment vessel 2 is smallest.

The suppression pool 12 is eccentric annulus like the upper drywell 3, because the wall of the upper drywell 3 is continuous to the wall of the suppression pool 12.

The quenchers 14 in the suppression pool 12 are distributed proportionally to the volume distribution of the suppression pool 12. Therefore, the quenchers 14 are distributed biased to the 0-degree side. That is preferable because the safety-relief valves 9 on the main steam pipes 4 in the upper drywell 3 are situated on the 0-degree side and the pipes between the safety-relief valves 9 and the quenchers 14 can be reduced. In addition, the vent pipes 15 are also advantageously distributed biased to the 0-degree side where the main steam pipes 4 are disposed which is assumed to have a rupture.

The volume of the suppression pool 12 is calculated based on a sum of the volumes of the upper drywell 3, the lower drywell 11 and the access tunnel 13 so as to condense the steam blown out.

The fuel storage pool 16 is disposed on the 180-degree side where the shallow portion of the fuel storage pool 16 above the upper drywall 3 is narrow.

In the second embodiment, the control rod drive mechanism 25 (not shown in FIG. 3 nor 4) is disposed above the reactor pressure vessel 1. Alternatively, the control rod drive mechanism 25 can be disposed below the reactor pressure vessel 1 as in FIG. 2 wherein other features described above can be maintained substantially the same.

According to the second embodiment described above the size of the reactor containment vessel 2 can be reduced by the eccentric arrangement of the reactor pressure vessel 1 and the reactor containment vessel 2. The height of the reactor containment vessel 2 can be reduced by the horizontal arrangement of the main steam pipes 4 and the feed water pipes 5. The volume of the access tunnels 13 can be reduced by shortening the access tunnels 13. The volume of the suppression pool 12 can also be reduced owing to the reduction of the above-mentioned volumes, and then, the total volume of the reactor containment vessel 2 can be reduced.

The shallow area in the fuel storage pool 16 is reduced by the eccentric arrangement of the reactor pressure vessel 1 and the reactor containment vessel 2. Thus, the area of the fuel storage pool 16 can be reduced.

The load and capacity of the reactor-containment-vessel air conditioner 6 of the present embodiment can be reduced, because it is disposed outside of the reactor containment vessel 2. In the prior art, the reactor-containment-vessel air conditioner 6 is disposed in the reactor containment vessel 2 and has to air-condition the air conditioner 6 itself However the volume of the reactor containment vessel 2 can be reduced, even if the reactor-containment-vessel air conditioner 6 is disposed inside of the reactor containment vessel 2. Then, the reactor-containment-vessel air conditioner 6 may be disposed inside of the reactor containment vessel 2.

The distances between the quenchers 14 and the safety-relief valves 9 can be reduced, according to disposing the suppression pool 12 offsetting toward the 0-degree. Furthermore, the vent pipes 15 can be distributed biased to the 0-degree side, approaching the main steam pipes 4 that might have an assumed rupture.

Numerous modifications and variations of the present invention are possible in light of the above teachings. It is, therefore, to be understood that, within the scope of the appended claims, the present invention can be practiced in a manner other than as specifically described herein.

This application is based upon and claims the benefits of priority from the prior Japanese Patent Applications No. 2002-219562, filed on Jul. 29, 2002; the entire content of which is incorporated herein by reference.

What is claimed is:

1. A reactor containment vessel of a boiling water reactor configured to contain a reactor pressure vessel, the reactor pressure vessel being connected to at least one main steam pipe which penetrates the reactor containment vessel at a main-steam-line penetration point, wherein:
the reactor containment vessel has a first side and a second side which is opposite to the first side;
the main-steam-line penetration point is disposed on a first side of the reactor containment vessel; and
distance between outer surface of the reactor pressure vessel and inner surface of the reactor containment vessel on the first side is longer than the distance on a second side.

2. The reactor containment vessel according to claim 1, wherein the reactor containment vessel has a non-circular horizontal cross-sectional shape;
the reactor containment vessel has a first axis and a second axis which is perpendicular to the first direction;
the span of the reactor containment vessel in the first axis is longer than the span in the second axis; and
the main-steam-line penetration point is disposed in a direction which is close to one way of the first axis.

3. The reactor containment vessel according to claim 1, further comprising:
a lower drywell disposed below the reactor pressure vessel;
a wetwell horizontally surrounding the lower drywell; and
a suppression pool of annular shape contained in the wet well; wherein:
the suppression pool has a first surface which is a surface of a wall on a side of the lower drywell and a second surface which is an inner surface of the containment vessel; and
distance between the first surface and the second surface on the first side is longer than the distance on the second side.

4. The reactor containment vessel according to claim 1, further comprising:
an air conditioner for the reactor containment vessel disposed outside of the reactor containment vessel.

5. The reactor containment vessel according to claim 1, further comprising:
an air conditioner for the reactor containment vessel disposed outside of the reactor containment vessel, wherein the air conditioner is communicated to the reactor containment vessel via an air-conditioner duct with an air-conditioner-duct isolation valve.

6. The reactor containment vessel according to claim 1, further comprising:
a feed water pipe connected to the reactor pressure vessel;
wherein:
the reactor containment vessel has a feed-water-line penetration point;
the feed water pipe which penetrates the reactor containment vessel at a feed-water-line penetration point;
the feed-water-line penetration point is disposed on the first side of the reactor containment vessel; and
the main-steam-line penetration point and the feed-water-line penetration point are arranged in a substantially same level.

7. The reactor containment vessel according to claim 1, further comprising:
a lower drywell disposed below the reactor pressure vessel;
a wetwell horizontally surrounding the lower drywell;
a suppression pool of annular shape contained in the wet well; and
an access tunnel penetrating the suppression pool, wherein the access tunnel is able to communicate between the lower drywell and outside of the reactor containment vessel on the second side of the reactor containment vessel.

8. The reactor containment vessel according to claim 1, further comprising:
an upper drywell containing upper part of the reactor pressure vessel, and the main steam pipe between the reactor pressure vessel and the main-steam-line penetration point;
a lower drywell disposed below the reactor pressure vessel;
a wetwell horizontally surrounding the lower drywell and having an annular suppression pool; and
a plurality of vent pipes communicating the upper drywell and the wetwell, the vent pipes being distributed biased to the first side of the reactor containment vessel.

9. The reactor containment vessel according to claim 1, further comprising a fuel storage pool configured to contain fuel assemblies taken out of the reactor pressure vessel when the boiling water reactor is out of operation, wherein the fuel storage pool is disposed on the second side of the reactor containment vessel.

10. A reactor containment vessel of a boiling water reactor configured to contain a reactor pressure vessel, the reactor pressure vessel being connected to at least one main steam pipe and at least one feed water pipe; wherein:
the reactor containment vessel has a main-steam-line penetration point and a feed-water-line penetration point: the main steam pipe penetrates the reactor containment vessel at a main-steam-line penetration point; the feed water pipe penetrates the reactor containment vessel and at a feed-water-line penetration point; and the main-steam-line penetration point and the feed-water-line penetration point are arranged at substantially same level.

11. The reactor containment vessel according to claim 1, wherein the reactor pressure vessel has a first circular horizontal cross-sectional shape, and the reactor containment vessel has a second circular horizontal cross-sectional shape which eccentrically surrounds the first circular horizontal cross-sectional shape.
